(19) United States
(12) Patent Application Publication
(10) Pub. No.: US 2024/0140041 A1
(43) Pub. Date: May 2, 2024

(54) Print On Demand

(71) Applicant: Sky Castle Studios, LLC, San Francisco, CA (US)

(72) Inventor: Teagan Morrison, Santa Monica, CA (US)

(73) Assignee: Sky Castle Studios, LLC, San Francisco, CA (US)

(21) Appl. No.: 18/383,435

(22) Filed: Oct. 24, 2023

Related U.S. Application Data
(60) Provisional application No. 63/419,649, filed on Oct. 26, 2022.

(51) Int. Cl. B29C 64/393; B33Y 10/00; B33Y 50/02; B33Y 80/00

(52) U.S. Cl. CPC B29C 64/393; B33Y 10/00; B33Y 50/02; B33Y 80/00

(57) ABSTRACT

Aspects of the disclosure are directed to printing a gaming piece. In accordance with one aspect, an apparatus includes a processor configured to a) render a 3-dimensional (3D) character to generate a rendered character piece, b) render a scene to generate a rendered scene, and c) combine the rendered scene and the rendered character piece to generate a combination; a memory coupled to the processor, the memory configured to store data of the scene, the rendered scene; the 3D character and the rendered character piece; and an interconnection databus coupling the processor to the memory. Also disclosed is rendering a 3-dimensional (3D) character to generate a rendered character piece; rendering a scene to generate a rendered scene; and combining the rendered scene and the rendered character piece to generate a combination.

### CLAIM OF PRIORITY UNDER 35 U.S.C. § 119

The present Application for Patent claims priority to Provisional Application No. 63/419,649 entitled “Print On Demand” filed Oct. 26, 2022, and assigned to the assignee hereof and hereby expressly incorporated by reference herein.

### TECHNICAL FIELD

This disclosure relates generally to the field of printing, and, in particular, to printing a game piece.

### BACKGROUND

Board games and card games are a popular form of entertainment. There are board games and card games for grade school children, for teenagers, for young adults and for seniors. Many board games are made up of pieces that are standard. The maker/manufacturer of the board games and card games pre-determines what each piece or each card would look like. A board game may be made up of pre-determined looking pieces, just as how the appearance of each card of a card game may be pre-determined by the maker/manufacturer. However, there's a desire by users to include board game characters or card deck characters that visually incorporate features of their own imagination.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides printing a game piece. Accordingly, an apparatus including: a processor configured to a) render a 3-dimensional (3D) character to generate a rendered character piece, b) render a scene to generate a rendered scene, and c) combine the rendered scene and the rendered character piece to generate a combination; a memory coupled to the processor, the memory configured to store data of the scene, the rendered scene; the 3D character and the rendered character piece; and an interconnection databus coupling the processor to the memory.

In one example, the apparatus further includes a printer coupled to the processor, the printer configured to generate a game piece based on the combination. In one example, the printer is a 2-dimensional (2D) printer and the game piece is a 2-dimensional (2D) character sheet. In one example, the printer is further coupled to the memory. In one example, the printer is coupled to the memory and the processor via the databus. In one example, the printer is a 2-dimensional (2D) printer and the game piece is a 2-dimensional (2D) playing card. In one example, the printer is a 3-dimensional (3D) printer and the game piece is a 3-dimensional (3D) template. In one example, the 3D template is created from a 3-dimensional (3D) printable mesh and color format processed from the 3-dimensional (3D) character.

Another aspect of the disclosure provides a non-transitory computer-readable medium storing computer executable code, operable on a device including at least one processor and at least one memory coupled to the at least one processor, wherein the at least one processor is configured to implement printing a game piece, the computer executable code including: instructions for causing a computer to render a 3-dimensional (3D) character to generate a rendered character piece; instructions for causing the computer to render a scene to generate a rendered scene; instructions for causing the computer to combine the rendered scene and the rendered character piece to generate a combination; and instructions for causing the computer to generate a game piece based on the combination.

In one example, the non-transitory computer-readable medium further includes instructions for causing the computer to use a rendering equation for the rendering the 3D character, wherein the rendering equation defines a mapping from an incident radiance Rᵢ to an output radiance Rₒ using an integral transform equation and a kernel function.

Another aspect of the disclosure provides a method including: rendering a 3-dimensional (3D) character to generate a rendered character piece; rendering a scene to generate a rendered scene; and combining the rendered scene and the rendered character piece to generate a combination.

In one example, the method further includes generating a game piece based on the combination. In one example, the game piece is a 2-dimensional (2D) character sheet. In one example, the game piece is a 2-dimensional (2D) playing card. In one example, the method further includes generating a 3-dimensional (3D) template as a game piece, wherein the generating is based on the combination and uses a 3-dimensional (3D) printable mesh and a color format processed from the 3-dimensional (3D) character.

In one example, the method further includes generating at least one image based on a 2-dimensional (2D) model, wherein the at least one image is a component of the rendered character piece. In one example, the method further includes generating at least one image based on a 3-dimensional (3D) model, wherein the at least one image is a component of the rendered character piece. In one example, the method further includes using a rendering equation for the rendering the 3D character, and wherein the rendering equation defines a mapping from an incident radiance Rᵢ to an output radiance Rₒ using an integral transform equation.

In one example, the rendering equation is an integral transform of the incident radiance Rᵢ to the output radiance Rₒ using a kernel function. In one example, the kernel function is a bidirectional reflectance distribution function (BRDF). In one example, the kernel function is one or more of the following: circularly symmetric, homogenous, spectrally-invariant, isotropic, or stationary. In one example, the kernel function is represented by one of the following: a) a Lambertian parametric model, b) a specular parametric model, c) a superposition of a diffuse model and a specular parametric model, d) a Phong model, e) a Phong-Blinn model, or f) a Torrance-Sparrow model.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates a first example flow diagram for creating a playable board game or a deck of cards or standee pieces.

FIG. 2 illustrates a second example flow diagram for creating a playable board game or a deck of cards or standee pieces.

FIG. 3 illustrates an example of a character piece with a foreground element.

FIG. 4 illustrates an example of a foreground, a character piece and a background shown in an expanded format.

FIG. 5 illustrates an example of a foreground, a character piece and a background shown in a combination format.

### DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

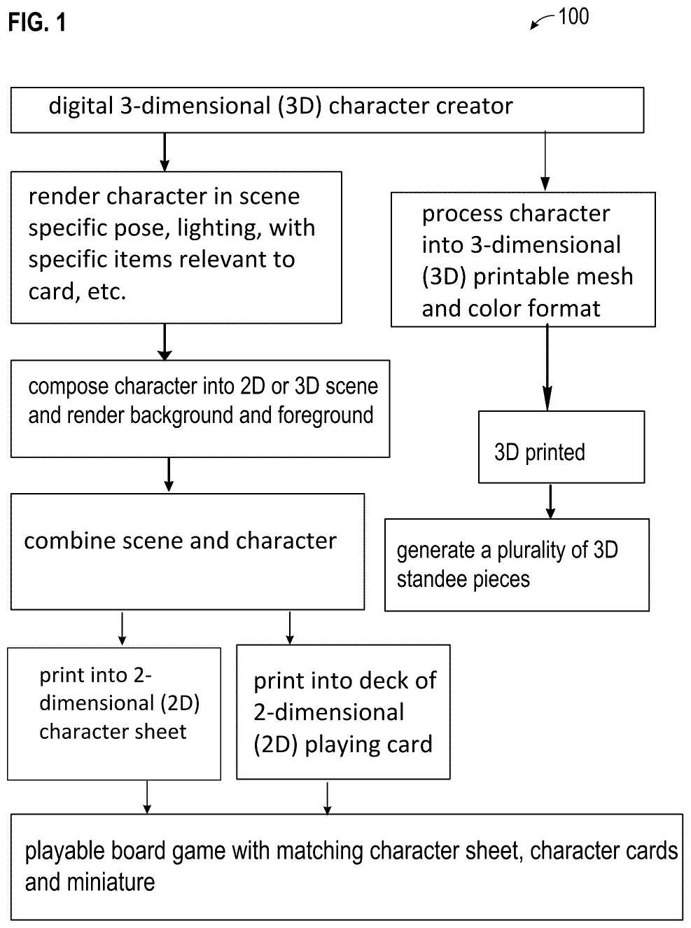

FIG. 1 illustrates a first example flow diagram 100 for creating a playable board game or a deck of cards or standee pieces. In one example, the character piece may be a piece in a board game or may be a card in a deck of cards. In one aspect, a user inputs a 3D digital character. A character piece is created based on the 3D character. Additional 3D characters may be used to create additional character pieces to complete a game set or a deck of cards. Thus, the resulting game set or deck of cards is customized for the user.

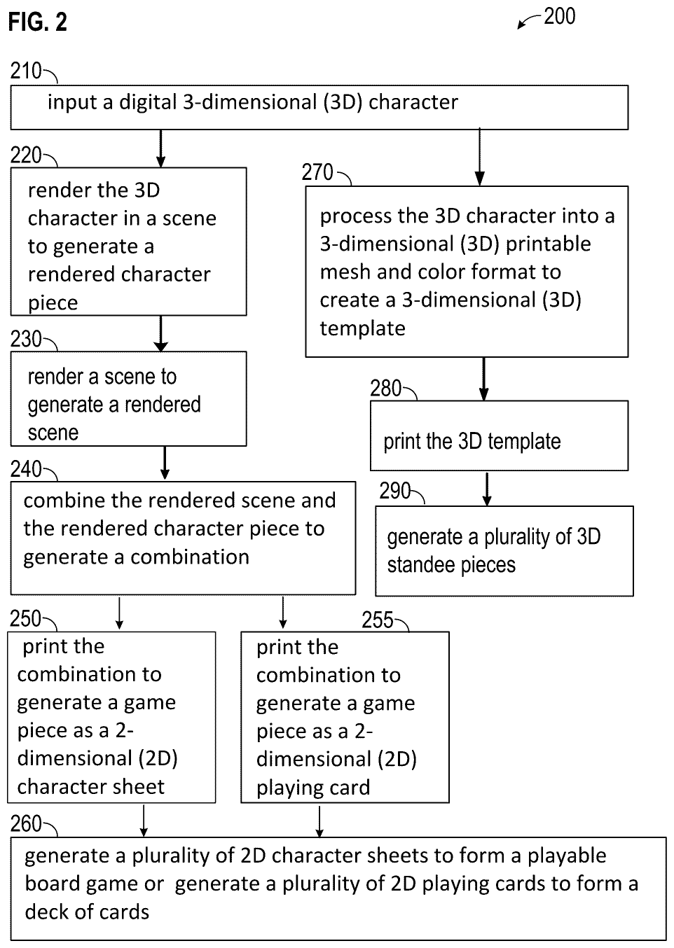

FIG. 2 illustrates a second example flow diagram 200 for creating a playable board game or a deck of cards or standee pieces. In block 210, input a digital 3-dimensional (3D) character. In one example, the 3D character is the baseline to be used for generating a character piece. In one example, the 3D character may be represented by a plurality of voxels, where a voxel is a three-dimensional sample of 3D space. In one example, the 3D character may be represented in a plurality of colors or spectral components, for example, red green blue (RGB). For example, each voxel may include three spectral components (e.g., RGB).

In block 220, render the 3D character in a scene to generate a rendered character piece. In one example, the 3D character is rendered in a scene specific pose, with a particular lighting selection and/or with one or more specific items relevant to a card in a deck of cards or a piece in a board game. In one example, the step of “rendering” is a process of generating an image from a 3-dimensional (3D) model (e.g. the 3D character) using a computer program. In another example, the step of “rendering” may use an image from a 2-dimensional (2D) model instead of a 3D model. In one example, the image is a component of the rendered character piece. In one example, the computer program allows the generation of the image taking into account the flow of light (and/or shades) that would appear on the image in a real-world setting.

For example, the computer program may implement a rendering equation which mathematically defines a mapping from input illumination (i.e., incident radiance) to output image (i.e., output radiance) to render the 3D character. For example, the computer program may implement the rendering equation by any of a plurality of rendering algorithms (e.g., finite element modeling, Monte Carlo methods, etc.).

In one example, radiance R is equal to radiant energy (in Joules) per unit time (in seconds) per unit solid angle (in steradians) per unit projected area (in square meters). For example, radiance may be expressed in units of J s⁻¹ sr⁻¹ m⁻². In one example, spectral radiance is radiance per unit frequency (expressed in units of J s⁻¹ sr⁻¹ m⁻² Hz⁻¹). In one example, spectral radiance is radiance per unit wavelength (expressed in units of J s⁻¹ sr⁻¹ m⁻² μm⁻¹).

In one example, incident radiance Rᵢ(r, kᵢ, λ, t) is the radiance incident at a point r from direction kᵢ, at a given wavelength λ and at a given time t. In one example, output radiance R₀(r, k₀, λ, t) is outgoing radiance at the point r from direction k₀, at given wavelength λ and at given time t. In one example, the output radiance R₀(r, k₀, λ, t) may be derived by an integral transformation of the incident radiance Rᵢ(r, kᵢ, λ, t) using a kernel function. In one example, the kernel function is a bidirectional reflectance distribution function (BRDF).

In one example, the rendering equation, which defines the mapping from incident radiance Rᵢ(r, kᵢ, λ, t) to output radiance R₀(r, k₀, λ, t), may be expressed mathematically by the following integral transform equation:

R₀(r,k₀,λ,t)=∫BRDF(r,kᵢ,k₀,λ,t)Rᵢ(r,kᵢ,λ,t)(kᵢ·n)dkᵢ,
where
r=position vector in 3D space
kᵢ=normalized vector of incident radiance direction or incidence direction vector
k₀=normalized vector of output radiance direction or output direction vector
λ=wavelength
t=time
BRDF(r, kᵢ, k₀, λ, t)=bidirectional reflectance distribution function from direction kᵢ to direction k₀ at position vector r for wavelength and time t
n=normal vector to surface at position vector r
(kᵢ·n)=vector dot product between kᵢ and n.

For example, the computer program may approximate the evaluation of the rendering equation by employing specific functional models of the bidirectional reflectance distribution function BRDF(r, kᵢ, k₀, λ, t). For example, a circularly symmetric form of the BRDF may be employed to reduce the dimensionality of the rendering equation. For example, a homogeneous form of the BRDF, where the BRDF is independent of position vector r, may be employed. For example, a spectrally-invariant form of the BRDF, where the BRDF is independent of wavelength λ, may be employed. For example, an isotropic form of the BRDF, where the BRDF is independent of the incident direction vector kᵢ and the output direction vector k₀, may be employed. For example, a stationary form of the BRDF, where the BRDF is independent of time t, may be employed. For example, other forms of the BRDF may be employed which use various combinations of the previous forms (e.g., a homogeneous, isotropic form of the BRDF which is independent of position vector r and independent of direction vectors kᵢ and k₀.

In one example, the BRDF may be represented as a parametric model. In one example, a parametric model is a mathematical expression for a function with one or more parameters, where a parameter is an adjustable constant for the function.

In one example, the BRDF may be represented by a Lambertian parametric model. In one example, the Lambertian parametric model represents the BRDF as a constant function over the direction vectors kᵢ and k₀ with a reflectance parameter ρ. In one example, the BRDF=ρ/π. In one example, the Lambertian parametric model represents uniform diffuse reflection.

In one example, the BRDF may be represented by a specular parametric model. In one example, the specular parametric model represents the BRDF with a two-dimensional impulse function δ(kᵢ,k₀). In one example, the specular parametric model represents specular reflection.

In one example, the BRDF may be represented by a superposition of a diffuse model and a specular model.

In one example, the BRDF may be represented by a Phong model. In one example, the Phong model represents the BRDF in the form k_{d}+kₛ cos^{m}(θ), where m is an integer and θ is an incidence angle. In one example, k_{d} represents a diffuse component of reflectivity and kₛ represents a specular component of reflectivity. That is, the Phong model is a superposition of both diffuse and specular components.

In one example, the BRDF may be represented by a Phong-Blinn model. In one example, the Phong-Blinn model represents the BRDF in the form k_{d}+kₛ (n·h)^{m}, where m is an integer and n=normal vector, h=halfway vector. In one example, k_{d} represents a diffuse component of reflectivity and kₛ represents a specular component of reflectivity. That is, the Phong-Blinn model is a superposition of both diffuse and specular components.

In one example, the BRDF may be represented by a Torrance-Sparrow model. In one example, the Torrance-Sparrow model includes a roughness parameter.

In block 230, render a scene to generate a rendered scene. In one example, a background and/or a foreground of the scene is rendered to generate a rendered scene. The rendered scene may be a 3-dimensional (3D) rendered scene or a 2-dimensional (2D) rendered scene.

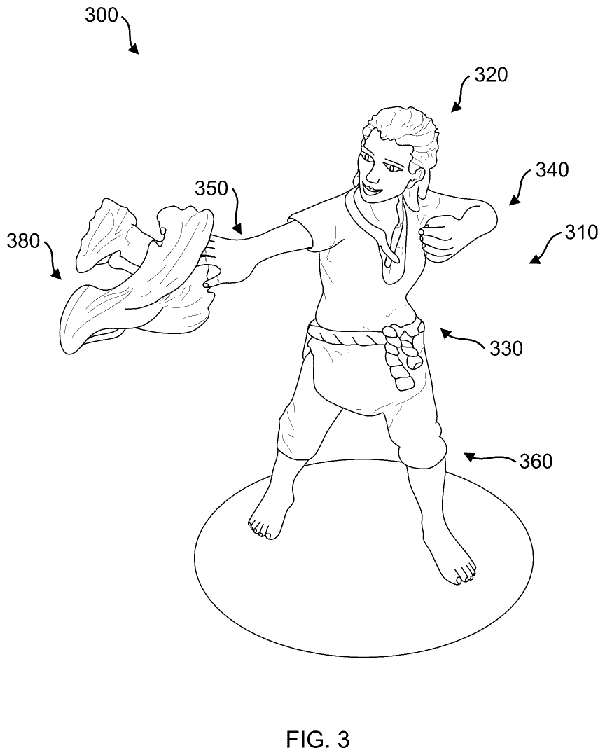

FIG. 3 illustrates an example 300 of a character piece 310 with a foreground element 380. In the example 300, the character piece 310 includes a right-hand feature 350. The right-hand feature 350 is positioned in 2-dimensions (2D) to match the foreground element 380. In one example, the right-hand feature 350 is matched in scale dimensionally to the rest of the character piece's other features (e.g., head feature 320, torso feature, 330, left-hand feature 340, leg feature 360). Additionally, in one example, the foreground element 380 is matched in scale dimensionally to the right-hand feature 350. Alternatively, in one example, the right-hand feature 350 is matched in scale dimensionally to the foreground element 380.

Returning to FIG. 2, in block 240, combine the rendered scene and the rendered character piece to generate a combination.

In block 250, print the combination to generate a game piece as a 2-dimensional (2D) character sheet.

Alternative to block 250, in block 255, print the combination to generate a game piece as a 2-dimensional (2D) playing card.

In block 260, following either block 250 or block 255, repeat the steps in blocks 210, 220, 230, 240 and 250 to generate a plurality of 2D character sheets to form a playable board game or repeat the steps in blocks 210, 220, 230, 240 and 255 to generate a plurality of 2D playing cards to form a deck of cards.

In one example, the playable board game or the deck of cards may include a hybrid format of 2-dimensional (2D) features or 3-dimensional (3D) features. For example, a proxy 3-dimensional (3D) mesh may represent the 2-dimensional (2D) art so that shadows may be cast accurately by the digital 3D character onto the character piece which is 2-dimensional.

In one alternative following block 210, in block 270, process the 3D character into a 3-dimensional (3D) printable mesh and color format to create a 3-dimensional (3D) template.

In block 280, print the 3D template. In one example, the print uses 3D printing to create the 3D template.

In block 290, repeat the steps in blocks 210, 270 and 280 to generate a plurality of 3D standee pieces based on a plurality of 3D templates. In one example, a 3D standee piece is 3-dimensional game piece with a planar surface onto which a character image is printed on, and the planar surface is coupled onto a base piece that enables the planar surface to stand in a vertical direction perpendicular to a flat surface of the base piece.

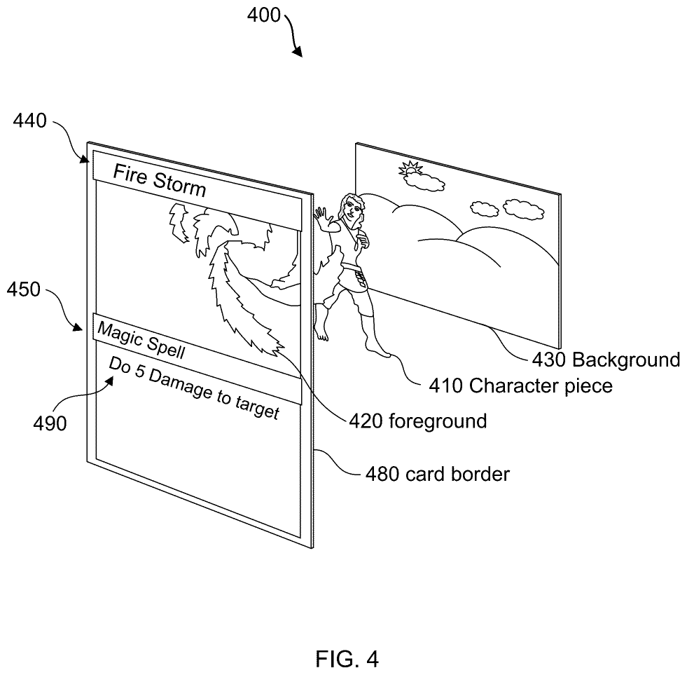

FIG. 4 illustrates an example 400 of a foreground 420, a character piece 410 and a background 430 shown in an expanded format. In one example, a card border 480 may be added to the example 400. In one example, a title 440 and/or text 450 may be added to the combination of the foreground 420, the character piece 410 and the background 430. In the example 400, a title of “Fire Storm” and text of “Magic Spell” are added. In one example, annotative text 490 may be added within the card border 480.

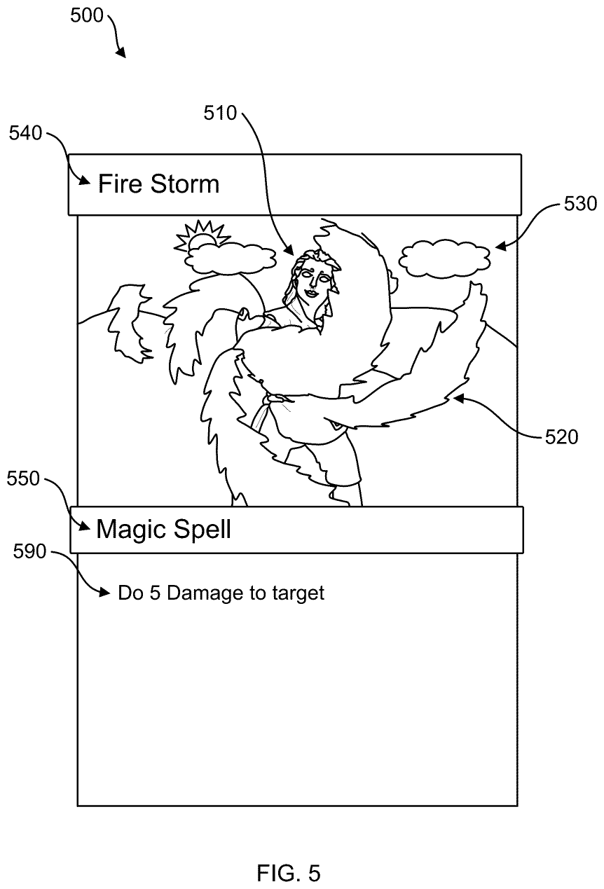

FIG. 5 illustrates an example 500 of a foreground 520, a character piece 510 and a background 530 shown in a combination format. In the example 500, a title 540, text 550 and annotative text 590 are included.

In one aspect, one or more of the steps for providing printing a game piece in FIGS. 1 and 2 may be executed by one or more processors which may include hardware, software, firmware, etc. The one or more processors, for example, may be used to execute software or firmware needed to perform the steps in the flow diagram of FIGS. 1 and 2. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
a processor configured to
a) render a 3-dimensional (3D) character to generate a rendered character piece,
b) render a scene to generate a rendered scene, and
c) combine the rendered scene and the rendered character piece to generate a combination;
a memory coupled to the processor, the memory configured to store data of the scene, the rendered scene; the 3D character and the rendered character piece; and
an interconnection databus coupling the processor to the memory.

2. The apparatus of claim 1, further comprising a printer coupled to the processor, the printer configured to generate a game piece based on the combination.

3. The apparatus of claim 2, wherein the printer is a 2-dimensional (2D) printer and the game piece is a 2-dimensional (2D) character sheet.

4. The apparatus of claim 3, wherein the printer is further coupled to the memory.

5. The apparatus of claim 4, wherein the printer is coupled to the memory and the processor via the data bus.

6. The apparatus of claim 2, wherein the printer is a 2-dimensional (2D) printer and the game piece is a 2-dimensional (2D) playing card.

7. The apparatus of claim 2, wherein the printer is a 3-dimensional (3D) printer and the game piece is a 3-dimensional (3D) template.

8. The apparatus of claim 7, wherein the 3D template is created from a 3-dimensional (3D) printable mesh and color format processed from the 3-dimensional (3D) character.

9. A non-transitory computer-readable medium storing computer executable code, operable on a device comprising at least one processor and at least one memory coupled to the at least one processor, wherein the at least one processor is configured to implement printing a game piece, the computer executable code comprising:
instructions for causing a computer to render a 3-dimensional (3D) character to generate a rendered character piece;
instructions for causing the computer to render a scene to generate a rendered scene;
instructions for causing the computer to combine the rendered scene and the rendered character piece to generate a combination; and
instructions for causing the computer to generate a game piece based on the combination.

10. The non-transitory computer-readable medium of claim 29, further comprising instructions for causing the computer to use a rendering equation for the rendering the 3D character, wherein the rendering equation defines a mapping from an incident radiance Rᵢ to an output radiance Rₒ using an integral transform equation and a kernel function.

11. A method comprising:
rendering a 3-dimensional (3D) character to generate a rendered character piece;
rendering a scene to generate a rendered scene; and
combining the rendered scene and the rendered character piece to generate a combination.

12. The method of claim 11, further comprising generating a game piece based on the combination.

13. The method of claim 12, wherein the game piece is a 2-dimensional (2D) character sheet.

14. The method of claim 12, wherein the game piece is a 2-dimensional (2D) playing card.

15. The method of claim 11, further comprising generating a 3-dimensional (3D) template as a game piece, wherein the generating is based on the combination and uses a 3-dimensional (3D) printable mesh and a color format processed from the 3-dimensional (3D) character.

16. The method of claim 11, further comprising generating at least one image based on a 2-dimensional (2D) model, wherein the at least one image is a component of the rendered character piece.

17. The method of claim 11, further comprising generating at least one image based on a 3-dimensional (3D) model, wherein the at least one image is a component of the rendered character piece.

18. The method of claim 11, further comprising using a rendering equation for the rendering the 3D character, and wherein the rendering equation defines a mapping from an incident radiance Rᵢ to an output radiance Rₒ using an integral transform equation.

19. The method of claim 18, wherein the rendering equation is an integral transform of the incident radiance Rᵢ to the output radiance Rₒ using a kernel function.

20. The method of claim 19, wherein the kernel function is a bidirectional reflectance distribution function (BRDF).

21. The method of claim 20, wherein the kernel function is one or more of the following: circularly symmetric, homogenous, spectrally-invariant, isotropic, or stationary.

22. The method of claim 20, wherein the kernel function is represented by one of the following:
a) a Lambertian parametric model,
b) a specular parametric model,
c) a superposition of a diffuse model and a specular parametric model,
d) a Phong model,
e) a Phong-Blinn model, or
f) a Torrance-Sparrow model.
